(19) United States
(12) Patent Application Publication
(10) Pub. No.: US 2016/0216620 A1
(43) Pub. Date: Jul. 28, 2016

(54) ELECTROPHOTOGRAPHIC PHOTOSENSITIVE MEMBER, METHOD FOR MANUFACTURING THE SAME, ELECTROPHOTOGRAPHIC APPARATUS, PROCESS CARTRIDGE, AND CHLOROGALLIUM PHTHALOCYANINE CRYSTAL

(71) Applicant: CANON KABUSHIKI KAISHA, Tokyo (JP)

(72) Inventors: Tsutomu Nishida, Mishima-shi (JP); Masataka Kawahara, Mishima-shi (JP); Masato Tanaka, Tagata-gun (JP)

(21) Appl. No.: 15/005,919

(22) Filed: Jan. 25, 2016

(30) Foreign Application Priority Data
Jan. 27, 2015 (JP) 2015-013727

(51) Int. Cl. G03G 15/00

(52) U.S. Cl. CPC G03G 5/0696; G03G 5/047

(57) ABSTRACT

An electrophotographic photosensitive member includes a support and a photosensitive layer in this order. The photosensitive layer of the electrophotographic photosensitive member contains a chlorogallium phthalocyanine crystal having peaks at 7.8°, 16.4°, 24.3°, and 27.8° in an X-ray diffraction pattern (Bragg angle: 2θ±0.2°) using the CuKα line.

### BACKGROUND OF THE INVENTION

1. Field of the Invention

The present invention relates to an electrophotographic photosensitive member, a method for manufacturing the same, an electrophotographic apparatus, a process cartridge, and a chlorogallium phthalocyanine crystal.

2. Description of the Related Art

As a charge generation material used for an electrophotographic photosensitive member, a gallium phthalocyanine pigment having a high sensitivity has been frequently used. However, because of its high sensitivity, there has been a problem in that the sensitivity is liable to be influenced by film thickness unevenness (hereinafter also referred to as “sensitivity unevenness” in some cases) of a photosensitive layer.

Japanese Patent Laid-Open No. 5-98181 has disclosed a chlorogallium phthalocyanine crystal which has diffraction peaks at Bragg angles)(2θ±0.2° of 7.4°, 16.6°, 25.5°, and 28.3° in an X-ray diffraction spectrum.

### SUMMARY OF THE INVENTION

In concomitance with recent further improvement in image quality, the characteristics of an electrophotographic photosensitive member have also been desired to be further improved. According to the results of investigation carried out by the present inventors, the chlorogallium phthalocyanine crystal disclosed in Japanese Patent Laid-Open No. 5-98181 has not sufficiently overcome the problem described above.

The present invention provides an electrophotographic photosensitive member which suppresses the sensitivity unevenness, a method for manufacturing the same, a process cartridge, and an electrophotographic apparatus. Furthermore, the present invention also provides a chlorogallium phthalocyanine crystal having a specific X-ray diffraction spectrum.

The present invention relates to an electrophotographic photosensitive member which includes a support and a photosensitive layer in this order, and the photosensitive layer described above contains a chlorogallium phthalocyanine crystal having peaks at 7.8°, 16.4°, 24.3°, and 27.8° in an X-ray diffraction pattern (Bragg angle: 2θ±0.2°) using the CuKα line.

Further features of the present invention will become apparent from the following description of exemplary embodiments with reference to the attached drawings.

### BRIEF DESCRIPTION OF THE DRAWINGS

FIG. 1 is a cross-sectional view showing one example of a schematic structure of an electrophotographic apparatus including a process cartridge which has an electrophotographic photosensitive member.

FIGS. 2A and 2B are each a cross-sectional view showing one example of a layer structure of an electrophotographic photosensitive member.

FIG. 3 is an X-ray diffraction chart of a chlorogallium phthalocyanine crystal obtained in Synthetic Example 1.

FIG. 4 is an X-ray diffraction chart of a chlorogallium phthalocyanine crystal obtained in Synthetic Example 2.

FIG. 5 is an X-ray diffraction chart of a chlorogallium phthalocyanine crystal obtained in Synthetic Example 3.

FIG. 6 is an X-ray diffraction chart of a chlorogallium phthalocyanine crystal obtained in Synthetic Example 4.

FIG. 7 is an X-ray diffraction chart of a chlorogallium phthalocyanine crystal obtained in Example 1.

FIG. 8 is an X-ray diffraction chart of a chlorogallium phthalocyanine crystal obtained in Example 2.

### DESCRIPTION OF THE EMBODIMENTS

As described above, an electrophotographic photosensitive member of the present invention includes a support and a photosensitive layer in this order. In addition, the photosensitive layer contains a chlorogallium phthalocyanine crystal having peaks at 7.8°, 16.4°, 24.3°, and 27.8° in an X-ray diffraction pattern (Bragg angle: 2θ±0.2°) using the CuKα line.

As for the reason the sensitivity unevenness is suppressed when a chlorogallium phthalocyanine crystal having peaks at the specific positions described above (at 7.8°, 16.4°, 24.3°, and 27.8° in an X-ray diffraction pattern (Bragg angle: 2θ±0.2°) using the CuKα line) is contained in the photosensitive layer, the present inventors have conceived as described below. It is believed that in the chlorogallium phthalocyanine crystal having the peaks at the specific positions described above, since a CT (charge-transfer) interaction between chlorogallium phthalocyanine molecules adequately works, and the dependence on electric field intensity of photoelectric conversion quantum efficiency has linearity, the sensitivity unevenness is suppressed.

The chlorogallium phthalocyanine crystal described above preferably contains in its crystal, at least one selected from the group consisting of N-ethylformamide, N,N-diisopropylformamide, and N-[dimethylamino]ethyl]-N-methylformamide. The content thereof is preferably 0.1 to 10 percent by mass.

The chlorogallium phthalocyanine crystal of the present invention can be obtained by the following step. That is, the chlorogallium phthalocyanine crystal of the present invention can be obtained by a step of performing crystal transformation using a wet milling treatment, in other words, by a step of mixing a solvent and a chlorogallium phthalocyanine crystal in which the half width of the maximum peak in an X-ray diffraction pattern using the CuKα line is 0.4° to 1.6°. A chlorogallium phthalocyanine crystal having a half width in the above range can be obtained, for example, by the following two methods. According to one method thereof, a gallium compound and a compound forming a phthalocyanine ring are allowed to reach with each other in a chlorinated aromatic compound to obtain a high crystalline chlorogallium phthalocyanine crystal. This chlorogallium phthalocyanine crystal is mixed with a sulfuric acid for acid pasting to obtain a low crystalline hydroxygallium phthalocyanine crystal. Subsequently, this low crystalline hydroxygallium phthalocyanine crystal is mixed with a hydrochloric acid, so that a chlorogallium phthalocyanine crystal having a half width in the range described above can be obtained. In addition, according to the other method, when the high crystalline chlorogallium phthalocyanine crystal obtained as described above is subjected to milling, a chlorogallium phthalocyanine crystal having a half width in the range described above can be obtained. Since this chlorogallium phthalocyanine crystal having a half width in the range described above has a slightly low crystallinity, the crystal transformation thereof can be effectively performed.

As the solvent used for wet milling performed in the crystal transformation step, for example, at least one selected from the group consisting of N-ethylformamide, N,N-diisopropylformamide, and N-[dimethylamino]ethyl]-N-methylformamide may be mentioned. Those solvents may be used alone, or at least two types thereof may be used in combination. When a wet milling treatment is performed using the solvent mentioned above, a chlorogallium phthalocyanine crystal having peaks at Bragg angles 2θ±0.2° of 7.8°, 16.4°, 24.3°, and 27.8° in an X-ray diffraction pattern using the CuKα line can be obtained.

The wet milling treatment performed in this embodiment is a treatment performed using a milling apparatus, such as a sand mill, a ball mill, or a paint shaker, together with a dispersion agent, such as glass beads, steel beads, or alumina balls. A milling time is preferably approximately 4 to 500 hours. The amount of the solvent used for the wet milling treatment is preferably 5 to 30 times that of gallium phthalocyanine on the mass basis.

Whether the chlorogallium phthalocyanine crystal contains in its crystal, N-ethylformamide, N,N-diisopropylformamide, and/or N-[dimethylamino]ethyl]-N-methylformamide or not is determined by analysis of data obtained by NMR measurement.

The X-ray diffraction measurement and the NMR measurement of the chlorogallium phthalocyanine crystal of the present invention were performed under the following conditions.

### (Powder X-Ray Diffraction Measurement)

Measurement apparatus: X-ray diffraction apparatus RINT-TTRII, manufactured by Rigaku Corp.
X-ray tube: Cu
Tube voltage: 50 kV
Tube current: 300 mA
Scan method: 2θ/θ scan
Scan speed: 4.0°/min
Sampling distance: 0.02°
Start angle (2θ): 5.0°
Stop angle (2θ): 40.0°
Attachment: reference sample holder
Filter: not used
Incidence monochromator: used
Counter monochromator: not used
Divergence slit: open
Divergence vertical limitation slit: 10.00 mm
Scattering slit: open
Receiving slit: open
Counter: scintillation counter

### (NMR Measurement)

Measurement apparatus: AVANCEIII 500, manufactured by BRUKER
Solvent: deuterated sulfuric acid (D₂SO₄)
Cumulative number: 2,000

The chlorogallium phthalocyanine crystal of the present invention has a superior function as a photoconductor and may also be applied to, besides an electrophotographic photosensitive member, a solar cell, a sensor, a switching element, and the like.

Next, the case in which the chlorogallium phthalocyanine crystal of the present invention is used as a charge generation material in an electrophotographic photosensitive member will be described.

An electrophotographic photosensitive member of the present invention includes a support and a photosensitive layer.

As the photosensitive layer, for example, there may be mentioned a monolayer type photosensitive layer containing a charge transport material and a charge generation material in the same layer and a laminate type (function separation type) photosensitive layer in which a charge generation layer containing a charge generation material is separately provided from a charge transport layer containing a charge transport material. In view of the electrophotographic characteristics, a laminate type photosensitive layer including a charge generation layer and a charge transport layer formed thereon is preferable.

FIGS. 2A and 2B are each a cross-sectional view showing one example of a layer structure of the electrophotographic photosensitive member of the present invention. FIG. 2A shows a monolayer type photosensitive layer in which an undercoating layer 102 is formed on a support 101, and a photosensitive layer 103 is formed on the undercoating layer 102. FIG. 2B shows a laminate type photosensitive layer in which an undercoating layer 102 is formed on a support 101, a charge generation layer 104 is formed on the undercoating layer 102, and a charge transport layer 105 is formed on the charge generation layer 104.

### [Support]

The support preferably has an electrical conductivity (electrically conductive support). For example, a metal, such as aluminum or stainless steel, or an alloy thereof may be mentioned as a material of the support. In addition, a metal, a plastic, or a paper support, each of which has an electrically conductive film on the surface thereof, may also be mentioned by way of example.

In addition, as the shape of the support, for example, a disc or a film shape may be mentioned.

In order to cover the unevenness of the surface of the support and/or to suppress the generation of interference stripes, an electrically conductive layer may be provided between the support and an undercoating layer which will be described later. The electrically conductive layer may be formed in such a way that a coating film is formed from an electrically conductive-layer coating liquid prepared by dispersing electrically conductive particles and a binder resin in a solvent and is then dried.

As the electrically conductive particles, for example, aluminum particles, titanium oxide particles, tin oxide particles, zinc oxide particles, carbon black, and silver particles may be mentioned. As the binder resin, for example, a polyester, a polycarbonate, a poly(vinyl butyral), an acrylic resin, a silicone resin, an epoxy resin, a melamine resin, a urethane resin, a phenol resin, and an alkyd resin may be mentioned. As the solvent for the electrically conductive-layer coating liquid, for example, an ether-based solvent, an alcohol-based solvent, a ketone-based solvent, and an aromatic hydrocarbon-based solvent may be mentioned.

The thickness of the electrically conductive layer is preferably 5 to 40 μm and more preferably 10 to 30 μm.

Between the support and the photosensitive layer, an undercoating layer (also called an intermediate layer) having a barrier function and/or an adhesive function may also be provided. The undercoating layer may be formed in such a way that a coating film is formed from an undercoating-layer coating liquid prepared by mixing a binder resin and a solvent and is then dried.

As the binder resin used for the undercoating layer, for example, a poly(vinyl alcohol), a poly(ethylene oxide), an ethyl cellulose, a methyl cellulose, a casein, a polyamide, a glue, and a gelatin may be mentioned. The thickness of the undercoating layer is preferably 0.1 to 10 μm and more preferably 0.3 to 5.0 μm.

### [Photosensitive Layer, Charge Generation Layer]

When the photosensitive layer is a laminate type photosensitive layer, the charge generation layer contains the chlorogallium phthalocyanine crystal of the present invention as a charge generation material. The charge generation layer may be formed in such a way that a coating film is formed from a charge generation-layer coating liquid prepared by dispersing a chlorogallium phthalocyanine crystal and a binder resin in a solvent and is then dried. When a chlorogallium phthalocyanine crystal is dispersed, as long as a binder resin is added, the crystal form of the chlorogallium phthalocyanine crystal is not changed.

The thickness of the charge generation layer is preferably 0.05 to 1 μm and more preferably 0.1 to 0.3 μm.

The content of the charge generation material in the charge generation layer is preferably 30 to 90 percent by mass with respect to the total mass of the charge generation layer and is more preferably 50 to 80 percent by mass.

As the charge generation material used for the charge generation layer, a material other than the chlorogallium phthalocyanine crystal of the present invention may also be used together therewith. In this case, the content of the chlorogallium phthalocyanine crystal of the present invention is preferably 50 percent by mass or more with respect to the total mass of the charge generation layer.

As the binder resin used for the charge generation layer, for example, a polyester, an acrylic resin, a phenoxy resin, a polycarbonate, a poly(vinyl butyral), a polystyrene, a poly(vinyl acetate), a polysulfone, a polyarylate, a poly(vinyl chloride), a poly(vinylidene chloride), an acrylonitrile copolymer, and a poly(vinyl benzal) may be mentioned. Among those mentioned above, a poly(vinyl butyral) and a poly(vinyl benzal) are preferable.

### [Photosensitive Layer, Charge Transport Layer]

The charge transport layer may be formed in such a way that a coating film is formed from a charge transfer-layer coating liquid prepared by dissolving a charge transfer material and a binder resin in a solvent and is then dried.

As the charge transport material, for example, a triarylamine compound, a hydrazone compound, a stilbene compound, a pyrazoline compound, an oxazole compound, a thiazole compound, and a triarylmethane compound may be mentioned. Among those mentioned above, a triarylamine compound is preferable.

As the binder resin used for the charge transport layer, for example, a polyester, an acrylic resin, a phenoxy resin, a polycarbonate, a polystyrene, a poly(vinyl acetate), a polysulfone, a polyarylate, a poly(vinylidene chloride), and an acrylonitrile copolymer may be mentioned. Among those mentioned above, a polycarbonate and a polyarylate are preferable.

The thickness of the charge transport layer is preferably 5 to 40 μm and more preferably 10 to 25 μm. The content of the charge transport material in the charge transport layer is preferably 20 to 80 percent by mass with respect to the total mass of the charge transport layer and is more preferably 30 to 60 percent by mass.

When the photosensitive layer is a monolayer type photosensitive layer, the photosensitive layer may be formed in such a way that a coating film is formed from a monolayer type photosensitive-layer coating liquid and is then dried. The monolayer type photosensitive-layer coating liquid may be prepared by mixing the chlorogallium phthalocyanine crystal of the present invention as a charge generation material, a charge transport material, a binder resin, and solvent.

In order to protect the photosensitive layer, a protective layer may be provided on the photosensitive layer.

The protective layer may be formed in such a way that a coating film is formed from a protective-layer coating liquid prepared by dissolving a binder resin in a solvent and is then dried. As the binder resin used for the protective layer, for example, a poly(vinyl butyral), a polyester, a polycarbonate, a nylon, a polyimide, a polyarylate, a polyurethane, a styrene-butadiene copolymer, a styrene-acrylic acid copolymer, and a styrene-acrylonitrile copolymer may be mentioned.

In addition, in order to impart a charge transport ability to the protective layer, the protective layer may be formed by curing a monomer having a charge transport ability (hole transport ability) using various types of polymerization reactions and cross-linking reactions. In particular, the protective layer is preferably formed by cuing a charge transport compound (hole transport compound) having a chain polymerizable functional group by polymerization or cross-linking.

The thickness of the protective layer is preferably 0.05 to 20 μm.

As a method for applying the coating liquid of each of the above layers, for example, a dipping method, a spray coating method, a spinner coating method, a bead coating method, a blade coating method, and a beam coating method may be mentioned.

A layer to be used as a surface layer of the electrophotographic photosensitive member may contain electrically conductive particles, an UV absorbing agent, and lubricant particles, such as fluorine atom-containing resin particles. As the electrically conductive particles, for example, metal oxide particles, such as tin oxide particles, may be mentioned.

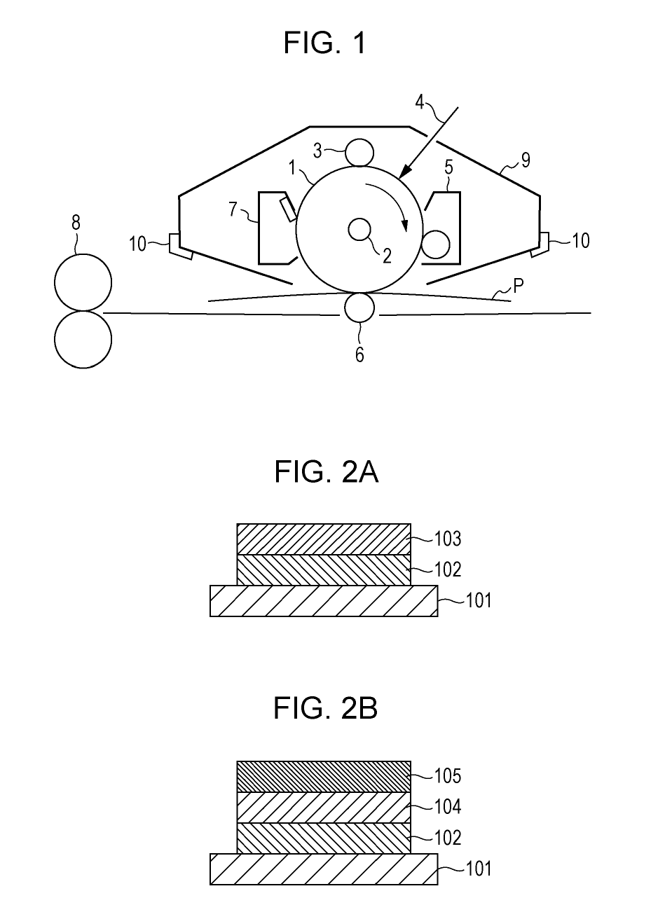

FIG. 1 is a cross-sectional view showing one example of a schematic structure of an electrophotographic apparatus including a process cartridge which has an electrophotographic photosensitive member.

A cylindrical (drum-shaped) electrophotographic photosensitive member 1 is rotationally driven around a shaft 2 in an arrow direction at a predetermined circumferential velocity (process speed).

The surface (circumferential surface) of the electrophotographic photosensitive member 1 is positively or negatively charged at a predetermined potential by a charging device (primary charging device) 3 in a rotation process. Next, the surface of the electrophotographic photosensitive member 1 is irradiated with exposure light (image exposure light) 4 emitted from an exposure device (image exposure device) (not shown), so that an electrostatic latent image corresponding to target image information is formed on the surface of the electrophotographic photosensitive member 1. The exposure light 4 is light which is emitted from an exposure device, such as slit exposure or laser beam scanning exposure, and which is intensity-modulated corresponding to a time-sequence electric digital pixel signal of the target image information.

The electrostatic latent image formed on the surface of the electrophotographic photosensitive member 1 is developed (normally developed or reversely developed) by a developing agent (toner) contained in a developing device 5, so that a toner image is formed on the surface of the electrophotographic photosensitive member 1. The toner image formed on the electrophotographic photosensitive member 1 is transferred onto a transfer material P by a transfer device 6. In this case, a voltage (transfer bias) having a polarity opposite to that of the toner is applied to the transfer device 6 by a bias power source (not shown). In addition, the transfer material P is taken out of a transfer material supply device (not shown) in synchronous with the rotation of the electrophotographic photosensitive member 1 and is then fed between the electrophotographic photosensitive member 1 and the transfer device 6.

The transfer material P on which the toner image is transferred is separated from the surface of the electrophotographic photosensitive member 1, is then transported to a fixing device 8, and is finally recovered as an image forming matter (a printed matter or a copied matter) out of the electrophotographic apparatus.

After the toner image is transferred onto the transfer material P, the surface of the electrophotographic photosensitive member 1 is cleaned by removing additives, such as a transfer-residual developing agent (residual toner), using a cleaning device 7. Alternatively, the residual toner may also be recovered using a developing device (cleanerless system) or the like.

Furthermore, the surface of the electrophotographic photosensitive member 1 is irradiated with pre-exposure light (not shown) emitted from a pre-exposure device (not shown) for a neutralization treatment and is repeatedly used for image formation. In addition, as shown in FIG. 1, when the charging device 3 is a contact type charging device using a charging roller or the like, the pre-exposure device may not be always required.

Among the constituent elements, such as the electrophotographic photosensitive member 1, the charging device 3, the developing device 5, the transfer device 6, and the cleaning device 7, a plurality of the constituent elements described above may be integrally received in one container to form a process cartridge. This process cartridge may be configured so as to be detachable to a main body of the electrophotographic apparatus. For example, at least one device selected from the charging device 3, the developing device 5, and the cleaning device 7 may be integrally supported together with the electrophotographic photosensitive member 1 to form a cartridge. In addition, by the use of a guide device 10, such as a rail, of the main body of the electrophotographic apparatus, a process cartridge 9 detachable thereto may be formed.

When the electrophotographic apparatus is a copying machine or a printer, the exposure light 4 may be light reflected from or transmitted through a manuscript. In addition, the exposure light 4 may be light emitted, for example, by scanning of laser beams, drive of an LED array, or drive of a liquid crystal shutter array, each of which is performed in accordance with signals prepared by reading a manuscript by a sensor.

### EXAMPLES

Hereinafter, the present invention will be described in more detail with reference to concrete examples. However, the present invention is not limited at all to the following examples. The “part(s)” which will be described below indicates “part(s) by mass”. In addition, the thickness of each layer of an electrophotographic photosensitive member of each of Examples and Comparative Example is measured by an eddy-current thickness meter (Fischer Scope, manufactured by Fisher Instrument) or calculated from the mass per unit area by specific gravity conversion.

### Synthetic Example 1

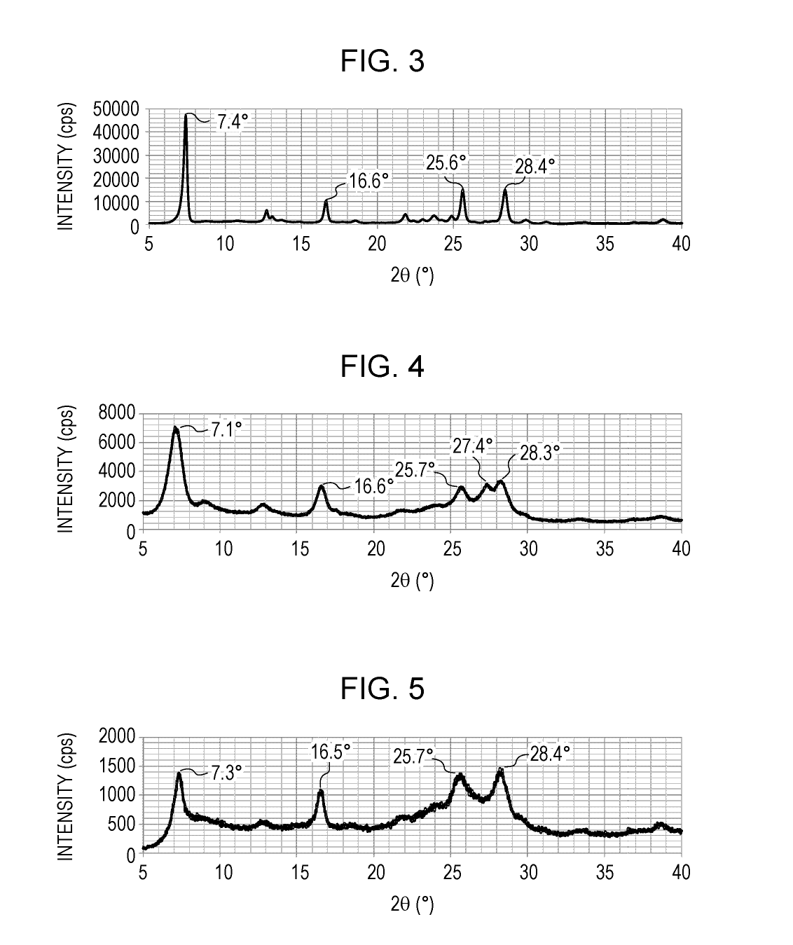

After 36.7 parts of ortho-phthalonitrile, 25 parts of trichlorogallium, and 300 parts of α-chloronaphthalene were allowed to reach with each other at 200° C. for 5.5 hours in a nitrogen atmosphere, a reaction product is filtrated at 130° C. After the product obtained thereby was dispersion-washed at 140° C. for 2 hours using N,N-dimethylformamide, filtration was performed, and the residue obtained thereby was washed with methanol and was then dried, so that 46 parts of a high crystalline chlorogallium phthalocyanine was obtained. This chlorogallium phthalocyanine was a crystal having peaks at Bragg angles 2θ of 7.4°, 16.6°, 25.6°, and 28.4° in CuKα characteristic X-ray diffraction. The half width of the maximum peak was 0.19°. The measurement result (X-ray diffraction chart) of the crystal form is shown in FIG. 3.

### Synthetic Example 2

After 24 parts of the chlorogallium phthalocyanine obtained in Synthetic Example 1 was dissolved in 750 parts of a concentrated sulfuric acid at 5° C., while being stirred, the solution thus obtained was dripped to 2,500 parts of ice water for re-precipitation. The precipitate obtained thereby was vacuum-filtrated. In this case, as a filter, No. 5C (manufactured by ADVANTEC) was used. Subsequently, after dispersion washing was performed for 30 minutes using 2%-ammonia water, dispersion washing was performed four times using ion-exchanged water. Freeze-drying was finally performed, so that a low crystalline hydroxygallium phthalocyanine crystal was obtained at a yield of 97%. This hydroxygallium phthalocyanine crystal was a crystal having peaks at Bragg angles 2θ of 6.9° and 26.4° in CuKα characteristic X-ray diffraction.

Next, 10 parts of this hydroxygallium phthalocyanine crystal was mixed with 200 parts of a hydrochloric acid aqueous solution at a concentration of 35 percent by mass and at a temperature of 23° C. This mixture solution was stirred for 90 minutes using a magnetic stirrer. After the stirring was performed, this solution was dripped to 1,000 parts of ion-exchanged water cooled with ice water and was stirred for 30 minutes using a magnetic stirrer. The solution thus processed was vacuum-filtrated. In this case, as a filter, No. 5C (manufactured by ADVANTEC) was used. Subsequently, dispersion washing was performed four times using ion-exchanged water. As described above, 9 parts of a chlorogallium phthalocyanine crystal was obtained. This chlorogallium phthalocyanine crystal was a crystal having peaks at Bragg angles 2θ of 7.1°, 16.6° C., 25.7° C., 27.4° C., and 28.3° in CuKα characteristic X-ray diffraction. The half width of the maximum peak was 0.89°. The measurement result (X-ray diffraction chart) of the crystal form is shown in FIG. 4. In addition, in Synthetic Example 2, the hydroxygallium phthalocyanine and the hydrochloric acid aqueous solution were allowed to reach with each other, so that the chlorogallium phthalocyanine was obtained.

### Synthetic Example 3

Paint shaker dispersion was performed at room temperature (23° C.) for 24 hours on a mixture containing 0.5 parts of the chlorogallium phthalocyanine obtained in Synthetic Example 1 and 15 parts of glass beads having a diameter of 1 mm, so that 0.41 parts of chlorogallium phthalocyanine was obtained. This chlorogallium phthalocyanine crystal was a crystal having peaks at Bragg angles 2θ of 7.3°, 16.5° C., 25.7° C., and 28.4° in CuKα characteristic X-ray diffraction. The half width of the maximum peak was 0.68°. The measurement result (X-ray diffraction chart) of the crystal form is shown in FIG. 5.

### Synthetic Example 4

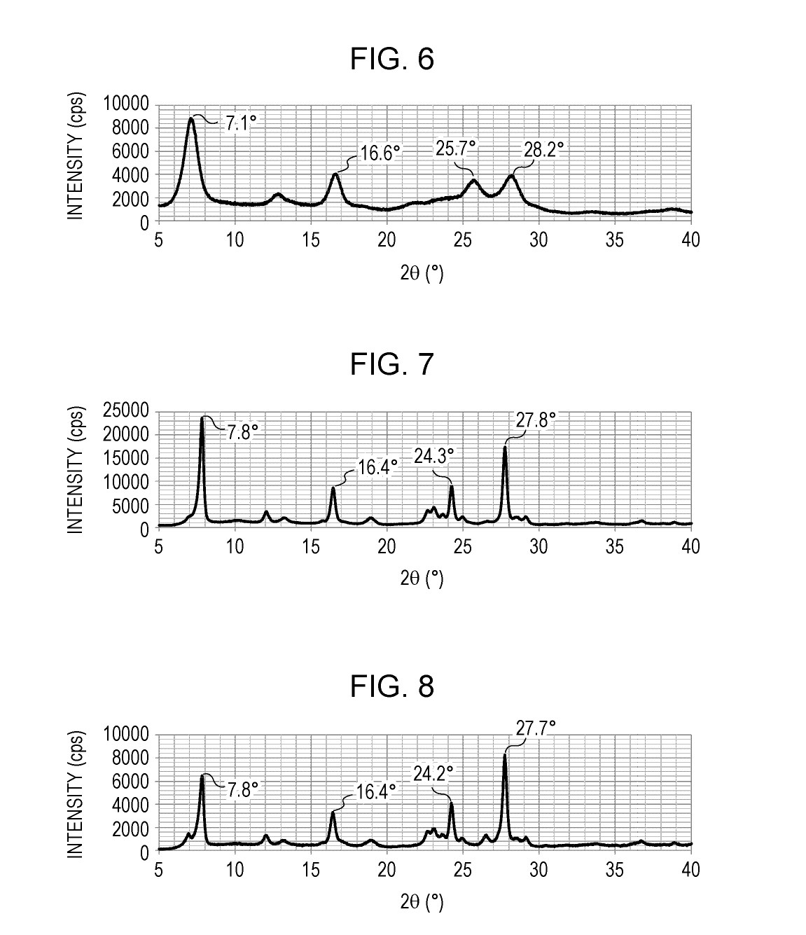

After 30 parts of 1,3-diiminoisoindoline, 8 parts of trichlorogallium, and 230 parts of dimethylsulfoxide were allowed to reach with each other at 150° C. for 12 hours in a nitrogen atmosphere, a reaction product was filtrated at 130° C. After the product obtained thereby was dispersion-washed at 140° C. for 2 hours using N,N-dimethylformamide, filtration was performed, and the residue obtained thereby was washed with methanol and was then dried, so that 28 parts of chlorogallium phthalocyanine was obtained. This chlorogallium phthalocyanine was processed by a treatment similar to that of Synthetic Example 2, so that a high crystalline chlorogallium phthalocyanine crystal was obtained. This chlorogallium phthalocyanine crystal was a crystal having peaks at Bragg angles 2θ of 7.1°, 16.6°, 25.7°, and 28.2° in CuKα characteristic X-ray diffraction. The half width of the maximum peak was 0.92°. The measurement result (X-ray diffraction chart) of the crystal form is shown in FIG. 6.

### Example 1

An aluminum cylinder (JIS-A3003, aluminum alloy) having a diameter of 24 mm and a length of 257 mm was used as a support (electrically conductive support).

Next, 60 parts of barium sulfate particles (trade name: Passtran PC1, manufactured by Mitsui Mining and Smelting Co., Ltd.) coated with tin oxide,

15 parts of titanium oxide particles (trade name: TITANIX JR, manufactured by Tayca Corporation),
43 parts of a resole type phenolic resin (trade name: PHENOLITE J-325, manufactured by DIC Corporation, solid content of 70 percent by mass),
0.015 parts of a silicone oil (trade name: SH28PA, manufactured by Dow Corning Toray Co., Ltd.), 3.6 parts of silicone resin particles (trade name: Tospearl 120, manufactured by Toshiba Silicone Co., Ltd.),
50 parts of 2-methoxy-1-propanol, and 50 parts of methanol were charged into a ball mill and were subjected to a dispersion treatment for 20 hours, so that an electrically conductive-layer coating liquid was prepared. This electrically conductive-layer coating liquid was applied onto the support by dipping to form a coating film, and the coating film thus obtained was cured by heating at 140° C. for 1 hour, so that an electrically conductive layer having a thickness of 15 μm was formed.

Next, 10 parts of a nylon copolymer (trade name: Amilan CM8000, manufactured by Toray Industries, Inc.) and 30 parts of methoxymethylated 6-nylon (trade name: Tresin EF-30T, manufactured by Teikoku Chemical Industry Co, Ltd.) were dissolved in a mixed solvent containing 400 parts of methanol and 200 parts of n-butanol, so that an undercoating-layer coating liquid was prepared. This undercoating-layer coating liquid was applied onto the electrically conductive layer by dipping to form a coating film, and the coating film thus obtained was dried at 80° C. for 6 minutes, so that an undercoating layer having a thickness of 0.42 μm was formed.

Subsequently, 1 part of the chlorogallium phthalocyanine crystal obtained in Synthetic Example 2, 20 parts of N-ethylformamide, and 30 parts of glass beads having a diameter of 1 mm were subjected to a wet milling treatment at room temperature (23° C.) for 24 hours using a ball mill. After the chlorogallium phthalocyanine crystal was recovered from this dispersion liquid using tetrahydrofuran, filtration was performed, and sufficient washing was performed over a filtration device with tetrahydrofuran. The filtrate obtained thereby was vacuum-dried, so that 0.86 parts of a chlorogallium phthalocyanine crystal was obtained. This chlorogallium phthalocyanine crystal was a crystal having peaks at Bragg angles 2θ of 7.8°, 16.4°, 24.3°, and 27.8° in CuKα characteristic X-ray diffraction. The measurement result (X-ray diffraction chart) of the crystal form is shown in FIG. 7. In addition, by the NMR measurement, besides the peaks derived from the chlorogallium phthalocyanine crystal, peaks derived from N-ethylformamide were also observed.

Next, 2 parts of this chlorogallium phthalocyanine crystal as a charge generation material, 1 part of a poly(butyl butyral) (trade name: S-LEC BX-1, manufactured by Sekisui Chemical Company Limited), and 52 parts of cyclohexanone were charged into a sand mill using glass beads having a diameter of 1 mm and were then subjected to a dispersion treatment for 6 hours. Subsequently, by addition of 75 parts of ethyl acetate, a charge generation-layer coating liquid was prepared.

This charge generation-layer coating liquid was applied onto the undercoating layer by dipping to form a coating film, and the coating film thus obtained was dried at 100° C. for 10 minutes. As a result, a charge generation layer was formed so that the thicknesses at 30 mm and 100 mm apart from the upper end of the support were each 0.16 μm.

Next, 28 parts of a compound (charge transport material (hole transport compound) represented by the following formula (C-1),

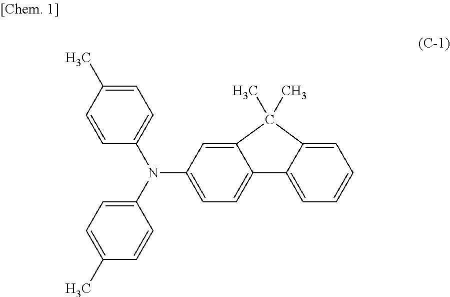 [SMILES: Cc1ccc(N(c2ccc(C)cc2)c2ccc3c(c2)C(C)(C)c2ccccc2-3)cc1]

4 parts of a compound (charge transport material (hole transport compound) represented by the following formula (C-2), and

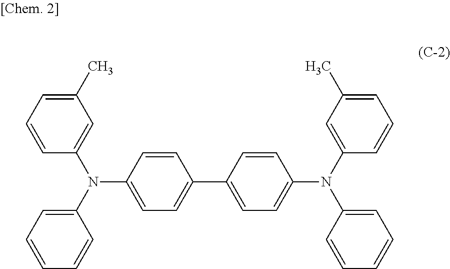 [SMILES: Cc1cccc(N(c2ccccc2)c2ccc(-c3ccc(N(c4ccccc4)c4cccc(C)c4)cc3)cc2)c1]

40 parts of a polycarbonate (trade name: Iupilon Z200, manufactured by Mitsubishi Engineering-Plastics Corporation) were dissolved in a mixed solvent containing 200 parts of monochlorobenzene and 50 parts of dimethoxymethane, so that a charge transport-layer coating liquid was prepared. This charge transport-layer coating liquid was applied onto the charge generation layer by dipping to form a coating film, and this coating film was dried at 120° C. for 30 minutes. As a result, a charge transport layer was formed so that the thicknesses at 30 mm and 100 mm apart from the upper end of the support were 12 μm and 16 μm, respectively.

As described above, a cylindrical (drum-shaped) electrophotographic photosensitive member of Example 1 was formed.

### Examples 2 to 7

Except that the chlorogallium phthalocyanine subjected to the wet milling treatment and the treatment conditions thereof in Example 1 were changed as shown in Table 1 to form a chlorogallium phthalocyanine crystal, an electrophotographic photosensitive member was formed in a manner similar to that of Example 1.

The chlorogallium phthalocyanine crystal used as the charge generation material in Example 2 was a crystal having peaks at Bragg angles 2θ of 7.8°, 16.4°, 24.2°, and 27.7° in CuKα characteristic X-ray diffraction.

The chlorogallium phthalocyanine crystal used as the charge generation material in Example 3 was a crystal having peaks at Bragg angles 2θ of 7.8°, 16.4°, 24.2°, and 27.8° in CuKα characteristic X-ray diffraction.

The chlorogallium phthalocyanine crystal used as the charge generation material in Example 4 was a crystal having peaks at Bragg angles 2θ of 7.7°, 16.3°, 24.3°, and 27.8° in CuKα characteristic X-ray diffraction.

The chlorogallium phthalocyanine crystal used as the charge generation material in Example 5 was a crystal having peaks at Bragg angles 2θ of 7.8°, 16.5°, 24.3°, and 27.9° in CuKα characteristic X-ray diffraction.

The chlorogallium phthalocyanine crystal used as the charge generation material in Example 6 was a crystal having peaks at Bragg angles 2θ of 7.9°, 16.4°, 24.4°, and 27.8° in CuKα characteristic X-ray diffraction.

The chlorogallium phthalocyanine crystal used as the charge generation material in Example 7 was a crystal having peaks at Bragg angles 2θ of 7.8°, 16.5°, 24.2°, and 27.7° in CuKα characteristic X-ray diffraction.

### Comparative Example 1

Except that in Example 1, the charge generation material was changed to the chlorogallium phthalocyanine of Synthetic Example 1, and the charge generation-layer coating liquid was prepared therefrom, an electrophotographic photosensitive member was formed in a manner similar to that of Example 1.

### Evaluation of Examples 1 to 7 and Comparative Example 1

The evaluation of the sensitivity unevenness was performed on the electrophotographic photosensitive member of each of Examples 1 to 7 and Comparative Example 1.

As an electrophotographic apparatus used for the evaluation, a laser beam printer (trade name: Color Laser Jet CP3525dn) manufactured by Hewlett-Packard Japan, Ltd. was used after being modified as described below. That is, the pre-exposure was not turned on, and the charging conditions and the image exposure amount were configured to be variably operated. In addition, the electrophotographic photosensitive member thus formed was mounted in a cyan-color process cartridge, and this process cartridge is fitted to a station therefor, and process cartridges for the other colors were configured to be operated without mounted onto a printer main body.

First, under normal temperature and normal humidity conditions at a temperature of 23° C. and a humidity of 55% RH, the charging conditions and the image exposure amount were adjusted so that, as the average potential in a circumference direction of the electrophotographic photosensitive member at a position 100 mm apart from the upper end of the support thereof, the dark potential was −450 V and the bright potential was −170 V. For the measurement of the surface potential of the cylindrical electrophotographic photosensitive member in potential setting, the cartridge was modified, and a potential probe (trade name: model6000B-8, manufactured by TREK Japan) was mounted on a developing position. Subsequently, the potential at a central portion of the cylindrical electrophotographic photosensitive member was measured using a surface electrometer (trade name: model344, manufactured by TREK Japan).

Subsequently, after a bright potential at a position 30 mm apart from the upper end of the support of the electrophotographic photosensitive member was measured under the same conditions as described above, the difference from the bright potential (−170 V) at a position 100 mm apart from the upper end of the electrophotographic photosensitive member was measured, and the sensitivity unevenness caused by the thickness unevenness of the charge transport layer was evaluated. The evaluation results are shown in Table 1. A potential difference of 20 V or less was preferable for the use.

TABLE 1

| | Milling conditions | | | | |
|---|---|---|---|---|---|
| | Chlorogallium | | | | |
| | phthalocyanine | | | | |
| | | Half | | | Evaluation |
| | | width | | Milling | Potential |
| | Synthesis | (°) | Solvent | apparatus | difference (V) |
| Example 1 | Synthetic | 0.89 | N-ethylformamide | Ball mill | 2 |
| | example 2 | | | | |
| Example 2 | Synthetic | 0.89 | N-ethylformamide | Paint | 3 |
| | example 2 | | | shaker | |
| Example 3 | Synthetic | 0.92 | N-ethylformamide | Ball mill | 6 |
| | example 4 | | | | |
| Example 4 | Synthetic | 0.49 | N-ethylformamide | Ball mill | 5 |
| | example 3 | | | | |
| Example 5 | Synthetic | 0.19 | N-ethylformamide | Ball mill | 12 |
| | example 1 | | | | |
| Example 6 | Synthetic | 0.89 | N,N-diisopropylformamide | Ball mill | 4 |
| | example 2 | | | | |
| Example 7 | Synthetic | 0.89 | N-[2-(dimethylamino)ethyl]-N- | Ball mill | 4 |
| | example 2 | | methylformamide | | |

| | | |
|---|---|---|
| Comparative | No milling treatment | 52 |
| Example 1 | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-013727, filed Jan. 27, 2015, which is hereby incorporated by reference herein in its entirety.

What is claimed is:

1. An electrophotographic photosensitive member comprising: a support; and a photosensitive layer in this order,
wherein the photosensitive layer contains a chlorogallium phthalocyanine crystal having peaks at 7.8°, 16.4°, 24.3°, and 27.8° in an X-ray diffraction pattern (Bragg angle: 2θ±0.2°) using the CuKα line.

2. The electrophotographic photosensitive member according to claim 1, wherein the chlorogallium phthalocyanine crystal contains in its crystal, at least one selected from the group consisting of N-ethylformamide, N,N-diisopropylformamide, and N-[2-(dimethylamino)ethyl]-N-methylformamide.

3. An electrophotographic photosensitive member comprising: a support; a charge generation layer; and a charge transport layer in this order,
wherein the charge generation layer contains a chlorogallium phthalocyanine crystal having peaks at 7.8°, 16.4°, 24.3°, and 27.8° in an X-ray diffraction pattern (Bragg angle: 2θ±0.2°) using the CuKα line.

4. The electrophotographic photosensitive member according to claim 3, wherein the chlorogallium phthalocyanine crystal contains in its crystal, at least one selected from the group consisting of N-ethylformamide, N,N-diisopropylformamide, and N-[2-(dimethylamino)ethyl]-N-methylformamide.

5. A method for manufacturing an electrophotographic photosensitive member having a support and a photosensitive layer in this order, the method comprising the steps of:
(i) mixing a chlorogallium phthalocyanine crystal in which the half width of the maximum peak in an X-ray diffraction pattern using the CuKα line is 0.4° to 1.6° and at least one solvent selected from the group consisting of N-ethylformamide, N,N-diisopropylformamide, and N-[2-(dimethylamino)ethyl]-N-methylformamide for crystal transformation to obtain a crystal-transformed chlorogallium phthalocyanine crystal; and
(ii) forming the photosensitive layer containing the chlorogallium phthalocyanine crystal obtained in the step (i).

6. The method for manufacturing an electrophotographic photosensitive member according to claim 5, wherein the chlorogallium phthalocyanine crystal obtained in the step (i) is a chlorogallium phthalocyanine crystal having peaks at 7.8°, 16.4°, 24.3°, and 27.8° in an X-ray diffraction pattern (Bragg angle: 2θ±0.2°) using the CuKα line.

7. A method for manufacturing an electrophotographic photosensitive member having a support, a charge generation layer, and a charge transport layer in this order, the method comprising the steps of:
(i) mixing a chlorogallium phthalocyanine crystal in which the half width of the maximum peak in an X-ray diffraction pattern using the CuKα line is 0.4° to 1.6° and at least one solvent selected from the group consisting of N-ethylformamide, N,N-diisopropylformamide, and N-[2-(dimethylamino)ethyl]-N-methylformamide for crystal transformation to obtain a crystal-transformed chlorogallium phthalocyanine crystal; and
(ii) forming the charge generation layer containing the chlorogallium phthalocyanine crystal obtained in the step (i).

8. The method for manufacturing an electrophotographic photosensitive member according to claim 7, wherein the chlorogallium phthalocyanine crystal obtained in the step (i) is a chlorogallium phthalocyanine crystal having peaks at 7.8°, 16.4°, 24.3°, and 27.8° in an X-ray diffraction pattern (Bragg angle: 2θ±0.2°) using the CuKα line.

9. A process cartridge which integrally supports an electrophotographic photosensitive member and at least one device selected from the group consisting of a charging device, a developing device, a transfer device, and a cleaning device and which is detachable to a main body of an electrophotographic apparatus,
wherein the electrophotographic photosensitive member includes a support and a photosensitive layer in this order, and
the photosensitive layer contains a chlorogallium phthalocyanine crystal having peaks at 7.8°, 16.4°, 24.3°, and 27.8° in an X-ray diffraction pattern (Bragg angle: 2θ±0.2°) using the CuKα line.

10. A process cartridge which integrally supports an electrophotographic photosensitive member and at least one device selected from the group consisting of a charging device, a developing device, a transfer device, and a cleaning device and which is detachable to a main body of an electrophotographic apparatus,
wherein the electrophotographic photosensitive member includes a support, a charge generation layer, and a charge transport layer in this order, and
the charge generation layer contains a chlorogallium phthalocyanine crystal having peaks at 7.8°, 16.4°, 24.3°, and 27.8° in an X-ray diffraction pattern (Bragg angle: 2θ±0.2°) using the CuKα line.

11. An electrophotographic apparatus comprising: an electrophotographic photosensitive member; a charging device; an exposure device, a developing device; and a transfer device,
wherein the electrophotographic photosensitive member includes a support and a photosensitive layer in this order, and
the photosensitive layer contains a chlorogallium phthalocyanine crystal having peaks at 7.8°, 16.4°, 24.3°, and 27.8° in an X-ray diffraction pattern (Bragg angle: 2θ±0.2°) using the CuKα line.

12. An electrophotographic apparatus comprising: an electrophotographic photosensitive member; a charging device; an exposure device; a developing device; and a transfer device,
wherein the electrophotographic photosensitive member includes a support, a charge generation layer, and a charge transport layer in this order, and
the charge generation layer contains a chlorogallium phthalocyanine crystal having peaks at 7.8°, 16.4°, 24.3°, and 27.8° in an X-ray diffraction pattern (Bragg angle: 2θ±0.2°) using the CuKα line.

13. A chlorogallium phthalocyanine crystal having peaks at 7.8°, 16.4°, 24.3°, and 27.8° in an X-ray diffraction pattern (Bragg angle: 2θ±0.2°) using the CuKα line.

14. The chlorogallium phthalocyanine crystal according to claim 13, wherein the chlorogallium phthalocyanine crystal contains in its crystal, at least one selected from the group consisting of N-ethylformamide, N,N-diisopropylformamide, and N-[2-(dimethylamino)ethyl]-N-methylformamide.
